(19) United States
(12) Patent Application Publication
(10) Pub. No.: US 2025/0028838 A1
(43) Pub. Date: Jan. 23, 2025

(54) GUIDED METHOD TO DETECT SOFTWARE VULNERABILITIES

(71) Applicant: Arm Limited, Cambridge (GB)

(72) Inventors: Michael Bartling, Austin, TX (US); Matthias Lothar Boettcher, Cambridge (GB); Brendan James Moran, Coton (GB)

(21) Appl. No.: 18/223,828

(22) Filed: Jul. 19, 2023

(51) Int. Cl. G06F 21/57

(52) U.S. Cl. CPC G06F 21/577; G06F 2221/033

(57) ABSTRACT

A method is provided that includes receiving a computer program comprising regions of code, each region of code including at least one function, pruning a search space of the received computer program by applying a high-level model recognizing potential software vulnerabilities to the computer program to determine a region of the code of the regions of code that includes a potential software vulnerability, performing a localized static analysis on the region of the code that include the potential software vulnerability to determine a local condition that causes the potential software vulnerability to be expressed in the computer program, and generating a report that includes the region of the code that includes the potential software vulnerability including a location of the region of the code within the computer program and the local condition that causes the potential software vulnerability to be expressed in the computer program.

### BACKGROUND

Automatically locating software vulnerabilities in the code can be essential to preventing potential attacks during deployment. In conventional computers and computer networks, an attack refers to various attempts to achieve unauthorized access to technological resources. While there are many tools for attempting to locate software vulnerabilities, these tools have shortcomings that limit their applicability. For example, tailored tools for locating software vulnerabilities usually target specific use cases, are overly expensive to run due to the breadth of the code and the processing time needed to analyze the code or get stuck exploring a strictly constrained search space.

### BRIEF SUMMARY

Methods for identifying potential vulnerabilities in source code and determining local conditions which cause the vulnerability to express are provided. The described methods apply a machine learning (ML) model to a source code to prune the search space of the subsequently executed code for a static analyzer. The combination of utilizing the ML model to prune the search space along with the static analyzer gives a more accurate result than either of the processes on their own. The output of the proposed method and system provides a software developer with the location of the software vulnerability as well as local conditions of a region of code containing the software vulnerability, such as viable input or system states, that make the software vulnerability exploitable.

A method for detecting software vulnerabilities includes receiving a computer program comprising regions of code, each region of code including at least one function, pruning a search space of the received computer program by applying a high-level model recognizing potential software vulnerabilities to the computer program to determine a region of the code of the regions of code that includes a potential software vulnerability, performing a localized static analysis on the region of the code that include the potential software vulnerability to determine a local condition that causes the potential software vulnerability to be expressed in the computer program, and generating a report that includes the region of the code that includes the potential software vulnerability including a location of the region of the code within the computer program and the local condition that causes the potential software vulnerability to be expressed in the computer program.

A non-transitory computer-readable medium is provided. The computer-readable storage medium includes instructions that when executed by a processing element perform a method. The method includes receiving a computer program comprising regions of code, each region of code including at least one function, pruning a search space of the received computer program by applying a high-level model recognizing potential software vulnerabilities to the computer program to determine a region of the code of the regions of code that includes a potential software vulnerability, performing a localized static analysis on the region of the code that include the potential software vulnerability to determine a local condition that causes the potential software vulnerability to be expressed in the computer program, and generating a report that includes the region of the code that includes the potential software vulnerability including a location of the region of the code within the computer program and the local condition that causes the potential software vulnerability to be expressed in the computer program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a schematic diagram of a software vulnerabilities detection system in accordance with one embodiment.

FIG. 2 illustrates a flowchart of a method for detecting software vulnerabilities in accordance with one embodiment.

FIG. 3 illustrates a region of code for a computer program written in the C++ computer language.

FIG. 4 illustrates a flow diagram corresponding to the region of code found in FIG. 3.

FIG. 5 illustrates a diagram of an example control flow graph for a region of source code having a potential software vulnerability.

FIG. 6 illustrates a diagram of the example control flow graph of FIG. 5 with the potential software vulnerability highlighted.

FIG. 7 illustrates a schematic diagram illustrating components of a computing system.

### DETAILED DESCRIPTION

Current methods of automatically locating software vulnerabilities include utilizing static analysis tools that examine the code without executing the program and, more recently, utilizing machine learning (ML) methods to locate software vulnerabilities. Traditional static analysis tools suffer from being difficult to use effectively as well as slow as they generally must explore the vast state spaces inherent to complex modern software. In addition, both static analysis tools and, especially, ML tools can produce false positives, such that the vulnerabilities the respective tool identified are not exploitable in most contexts. Likewise, false negatives, or missed potential vulnerabilities arise as a byproduct of the scale of the search space for each tool.

Machine learning (ML) techniques are being developed to detect software vulnerabilities. Recently ML has gained popularity by reasoning on source materials, e.g., code, directly, whether that is in recommending algorithms, common bug fixes, or generating high performance code given a high-level specification. However, even using the current state of the art ML models to locate software vulnerabilities, the results are only adequate at best. The problem using ML is twofold. First, the ML often targets a specific architecture, e.g., the specific processor the code executes on, and thus makes assumptions about the runtimes for the specific architecture. Second, these models generally do not ‘reason’ on the local context of the vulnerability and merely output that the vulnerability could be present in a specific region of the code.

Methods for identifying potential vulnerabilities in source code and determining local conditions which cause the vulnerability to express are provided. For the purposes of this application, a software vulnerability can be a normal vulnerability, a software weakness, or more generally, other common software bugs that can impact security. A normal vulnerability can be unexpected computer behavior (bug, misconfiguration, undefined behavior, or otherwise) leading an actor to obtain unintended privileges such as access to resources, ability to run code, tamper with data, repudiate actions, deny service, and exfiltrate confidential information (e.g., the STRIDE model for identifying computer security threats). The method applies an ML model to a computer program to prune the search space of the computer program. The pruned search space, e.g., a region of the code, is then input into a static analyzer for a localized static analysis. The proposed method provides a software developer with the location of the software vulnerability as well as a local condition, such as inputs or system state, for example, that make the specific software vulnerability exploitable.

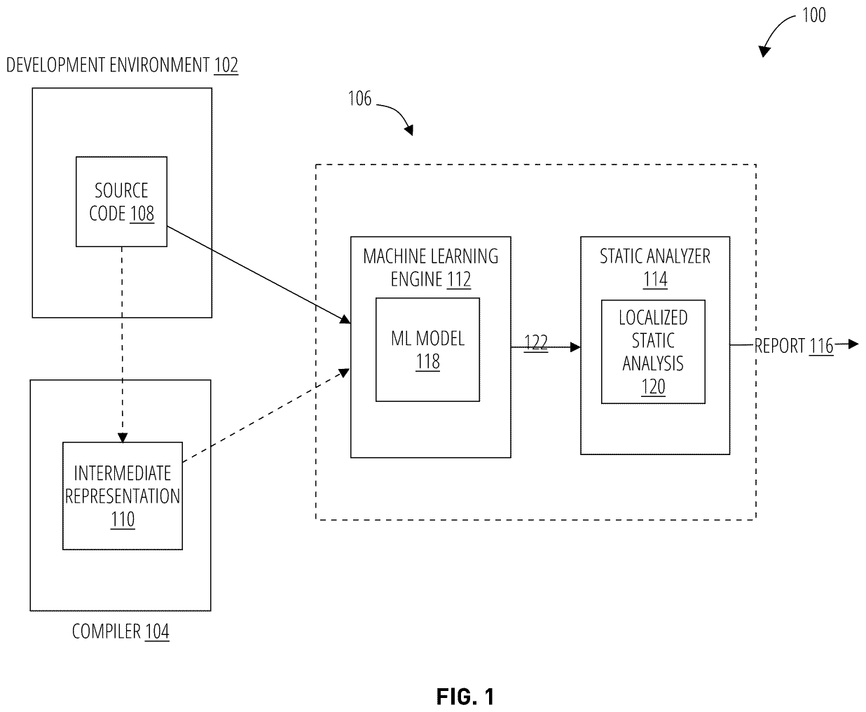

FIG. 1 illustrates a schematic diagram of an operating environment for a software vulnerabilities detection system in accordance with one embodiment. Referring to FIG. 1, operating environment 100 includes development environment 102, compiler 104, and software vulnerability detection system 106.

Software developers can develop source code 108 within the development environment 102. The development environment 102 is the tool used by software developers to efficiently develop a code or program. The development environment 102 can include a compiler 104 or the compiler 104 can be on a separate computing device as shown in FIG. 1. Compiler 104 translates the source code 108 from a high-level programming language to a lower level, such as to an intermediate representation 110, and ultimately to executable code.

One of skill in the art will understand that source code 108 can be in any programming language. An intermediate representation of source code is any representation of the code between the source code 108 and the executable code. The compiler 104 uses the intermediate representation 110 to represent the source code 108. In an embodiment, the intermediate representation 110 is a control flow graph showing the paths of the code using graph notation.

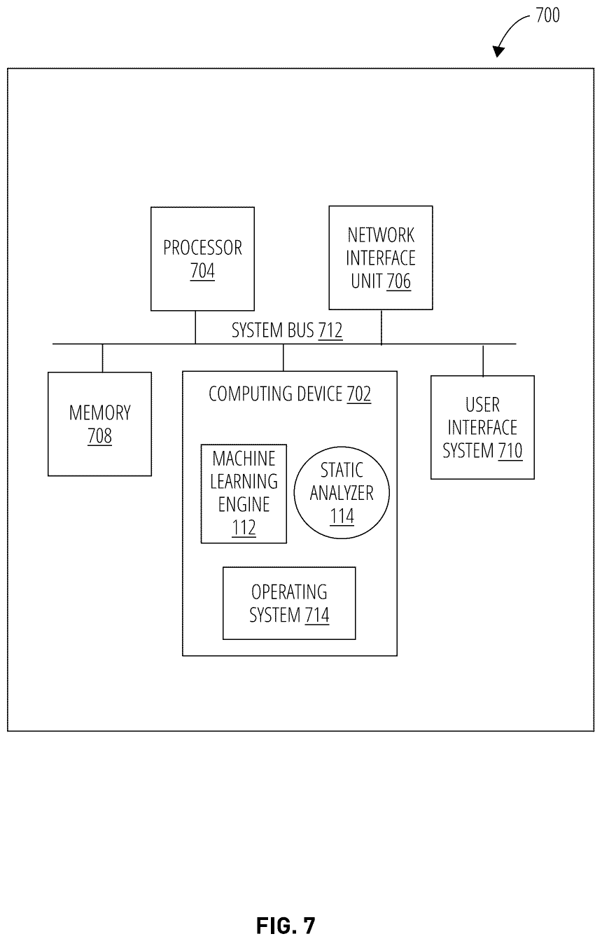

The software vulnerability detection system 106 is part of the development pipeline for the computer program. In some cases, software vulnerability detection system 106 can be part of compiler 104 when it is utilizing the intermediate representation 110 of the source code 108. In other cases, when software vulnerability detection system 106 is operating directly on source code 108, software vulnerability detection system 106 can be independent of the compiler 104 and hosted on a computing system 700, such as that shown in FIG. 7, separate from the compiler 104 and development environment 102 on a developer's computing device.

A computer program in the form of source code 108 is input into the software vulnerability detection system 106. Alternately, the intermediate representation 110 of the source code 108 can be input into the software vulnerability detection system 106. Software vulnerability detection system 106 comprises a machine learning engine 112 and a static analyzer 114. Based on a combination of the machine learning engine 112 and the static analyzer 114, software vulnerability detection system 106 performs analysis on the computer program to produce a report 116 that includes findings discovered during the analysis.

Machine learning engine 112 includes ML model 118. ML model 118 can be a high-level model utilizing deep learning or can use various neural networks. In some cases, e.g., when source code 108 is input into the machine learning engine 112, the ML model 118 can comprise a large language model (LLM). An LLM is a trained deep-learning ML model that can understand and generate text in a fashion that humans can read and understand. The LLM can be trained to analyze the source code 108 and output regions of code having potential software vulnerabilities. In other cases, e.g., when an intermediate representation 110 in the form of a control flow graph, is input into the machine learning engine 112, the ML model 118 can comprise a graph neural network (GNN). As discussed above, the accuracy of the machine learning models to correctly predict software vulnerabilities is still adequate at best. While LLMs and GNNs are discussed as the ML model used by the software vulnerability detection system 106, this is merely for exemplary purposes. Other ML models can be utilized by software vulnerability detection system 106 as well. The ML model 118 is used by software vulnerability detection system 106 to prune the search space of the computer program for the static analyzer 114.

Static analyzer 114 performs localized static analysis 120 on the output of ML model 122, i.e., the regions of code having potential software vulnerabilities. Static analyzers 114 examine code to find issues with the code without executing the code. The static analyzer 114 may perform one or more types of static analyses mentioned herein. A challenge associated with the utilization of current static analysis tools is that they require a lot of state space exploration. Thus, after applying the ML model 118 to the computer program, a much smaller subset of the code, e.g., a region(s) of code, is presented to the static analyzer 114 to perform localized static analysis 120.

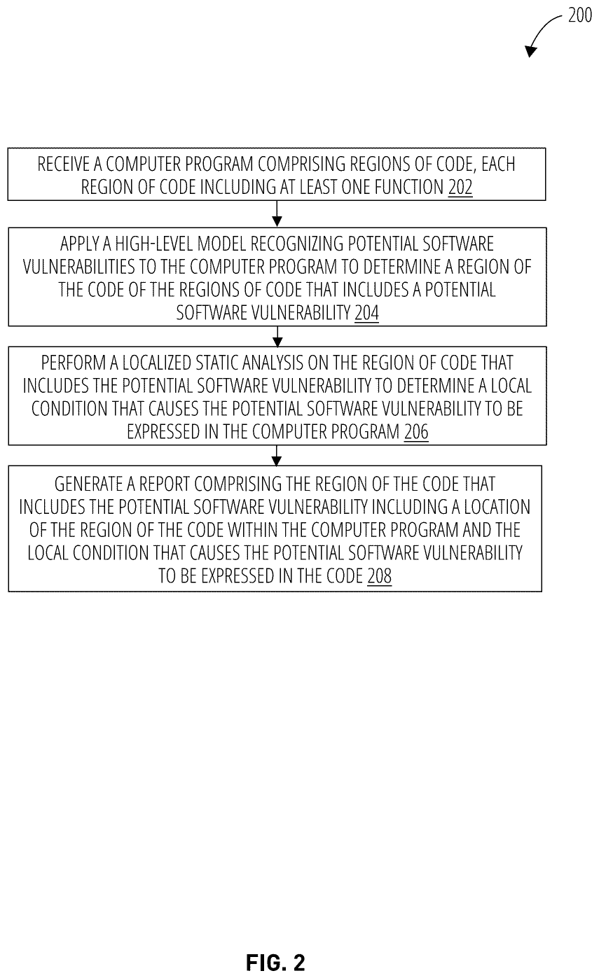

FIG. 2 illustrates a flowchart of a method for detecting software vulnerabilities in accordance with one embodiment. Method 200 can be performed by computing device 702 that includes machine learning engine 112 and static analyzer 114.

Referring to FIG. 2, method 200 receives (202) a computer program comprising regions of code, each region of code including at least one function. Further, method 200 applies (204) a high-level model recognizing potential software vulnerabilities to the computer program to determine a region of the code of the regions of code that includes a potential software vulnerability. Further, method 200 performs (206) a localized static analysis on the region of the code that includes the potential software vulnerability to determine a local condition that causes the potential software vulnerability to be expressed in the computer program. Further, method 200 generates (208) a report comprising the region of the code that includes the potential software vulnerability, including a location of the region of the code within the computer program, and the local condition that causes the potential software vulnerability to be expressed in the computer program.

After receiving (202) the computer program that comprises regions of code, each region of code including at least one function, the software vulnerability detection system 106 applies (204) ML model 118 in the machine learning engine 112 to the computer program. The ML model 118 analyzes the received computer program for software vulnerabilities and outputs the potential software vulnerabilities it finds. In some cases, the output can include highlighted regions of code. In other cases, the output can include a control flow graph.

As stated above, the ML model 118 does not produce completely accurate results. Thus, the output of ML model 122, e.g., region of code that contains a potential software vulnerability can be one of four possible outcomes. The first possible outcome is that the potential software vulnerability is real and exploitable. The software vulnerability is reachable in the computer program and can be a problem such that an attacker can attack the computer program using an exploit of the software vulnerability. These are obviously the software vulnerabilities that are essential for the developer to locate. The second possibility is that the potential software vulnerability is not a problem at all and the ML model 118 has output a false positive, such that the output region of code is fine and does not contain a software vulnerability. It is desired to eliminate these potential software vulnerabilities as they, in sufficient numbers, could hide true positives in a sea of false positives. The third possibility is that the potential software vulnerability is a problem, e.g., a software vulnerability, however, there are local conditions that prevent the software vulnerability from being expressed in the computer program, e.g., the potential software vulnerability is not reachable in the computer program. The fourth possibility is that the potential software vulnerability is a problem, e.g., a software vulnerability, and there are no conditions that prevent it but the region of code having the software vulnerability is only given arguments due to conditions in another region of code such that it will never be expressed in the computer program, e.g., the potential software vulnerability is not reachable in the computer program. Thus, only the first possible outcome, e.g., the real software vulnerability that is expressed in the code and reachable during operation, is the software vulnerability that is desired to be detected. The ML model 118 can present all of these possible outcomes to the static analyzer 114. However, with the analysis performed by the ML model 118, the search space of the computer program is thus pruned for the static analyzer 114.

The static analyzer 114 performs (206) a localized static analysis 120 on the output of ML model 122, e.g., the region of code having a potential software vulnerability, to determine one or more local conditions that cause the potential software vulnerability to be expressed in the computer program. There are at least a couple of ways to perform the localized static analysis 120.

In some cases, performing (206) the localized static analysis 120 includes locating a function boundary of a function of the computer program before the region of code that includes the potential software vulnerability and proceeding forward in the code to determine one or more local conditions that cause the potential software vulnerability to be expressed in the computer program. The distance the function boundary of a function is from the region of code influences the accuracy of the solution, e.g., the local condition that causes the potential software vulnerability to be expressed in the computer program. Thus, the further back in the code from the potential software vulnerability the localized static analysis 120 is started, the more exact the solution can be, e.g., the higher the likelihood that a potential vulnerability may be discarded as unexploitable due to a set of impossible conditions required to reach it. However, starting the localized static analysis 120 further back in the code from the potential software vulnerability, increases the search space of the code as there would be more functions that could potentially call the function(s) in the region of code having the potential software vulnerability. Thus, the simplest case is to locate a function boundary closest to the region of code having the potential software vulnerability and proceed forward in the code to determine the one or more local conditions that causes the potential software vulnerability to be expressed in the computer program. If the potential software vulnerability persists, another localized static analysis 120 can be performed from further back in the code.

In other cases, performing (206) the localized static analysis 120 includes locating a function boundary of a function of the computer program before the region of code that includes the potential software vulnerability and proceeding backwards from the region of code to the function boundary to determine one or more local conditions that cause the potential software vulnerability to be expressed in the computer program.

In some cases, the local condition can be an input to the function of the region of code having the potential software vulnerability. Similarly, the local condition can be an input to another function of the computer program at a function boundary located before the region of code that causes the potential software vulnerability to be expressed in the region of code. In other cases, the local condition can be an estimated system state of a processor that executes the computer program when the region of code that includes the potential software vulnerability is executed. The state of the processor when the potential software vulnerability is expressed can include the contents of configuration registers, e.g., specifying in which exception level code is being executed, data residing in buffer structures, e.g., caches, translation lookaside buffers (TLBs), branch predictors, processor internal queue structures, etc., i.e., anything that can affect the execution of the processor. System state can also include all locally accessible local/global variables, file descriptors, thread/process contexts, etc. In some cases, the localized static analysis 120 can include a scan of the region of code to infer additional contextual information such as process/thread trees, simulated network/file system traffic, etc.

As an example, the local condition can be a version of the surrounding software environment. The potential software vulnerability may rely on an outdated version of a library, API, protocol, etc. The potential software vulnerability will then become unexploitable if the developer adds code so that the region of code having the potential software vulnerability is preceded with a check for the required version.

The method 200 includes generating (208) a report 116 with the output of the software vulnerability detection system 106. The output can include the region of the code that includes the potential software vulnerability, the location of the region of the code within the computer program, and the local condition that causes the potential software vulnerability to be expressed in the computer program. Utilizing the report 116, a process or a software developer can then determine if the potential software vulnerability with the local condition that causes the potential software vulnerability is reachable and/or reasonable in the computer program when using the applied stimuli, e.g., state, user/network/file input data, and configuration of the computer program. For example, an application may rely on external data to execute dynamic content. An unsafe implementation may execute dynamic content without prior checks, potentially enabling attackers to inject arbitrary code into the application. The developer can discard these vulnerabilities if he/she knows that malicious data cannot reach the application or if the application is otherwise hardened against it.

For example, a potential software vulnerability made exploitable by an input that is greater than 1 MB when the network protocol used to feed a corresponding function that is limited to 1 KB may not be considered a software vulnerability that is at risk. Alternatively, the developer might want to enforce the 1 MB limit with a runtime check inside the function or remove the limitation from the region of code having the potential software vulnerability.

In some cases, the ML model 118 can create an exploitation of the potential software vulnerability. Utilizing the exploitation may assist the static analyzer 114 determine the local conditions that cause the potential software vulnerability to be expressed in the computer program.

In some cases, the method 200 further includes generating a set of conditions for a function at a function boundary before the region of code 300. The set of conditions can be generated using the potential software vulnerability and the local condition that causes the potential software vulnerability to be expressed in the computer program in order to prevent the function from being expressed in the computer program. A model checker can be used to demonstrate that the function is not expressed in the computer program.

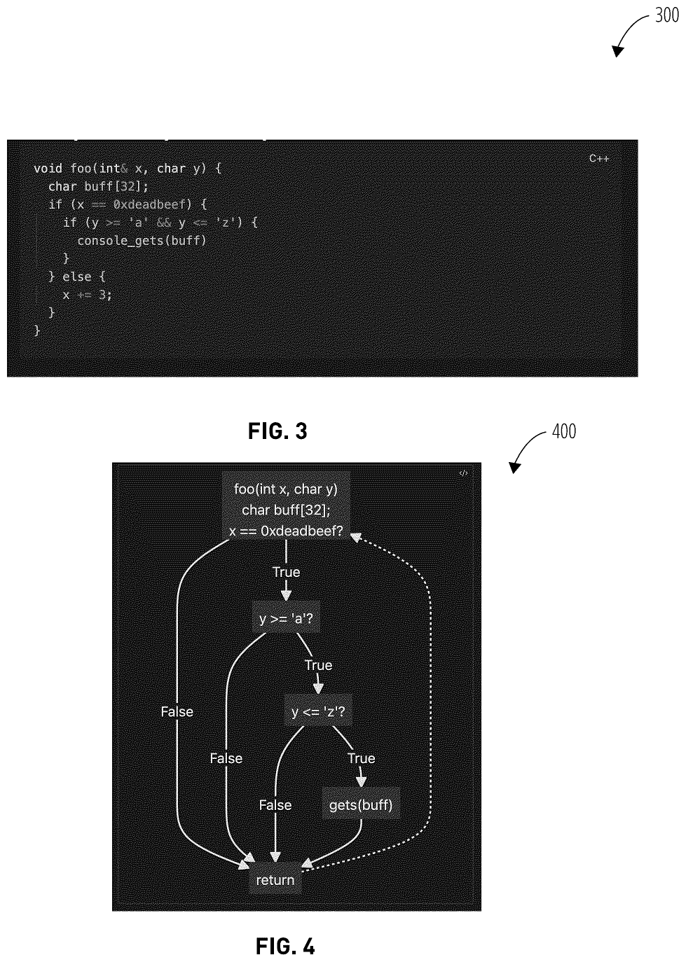

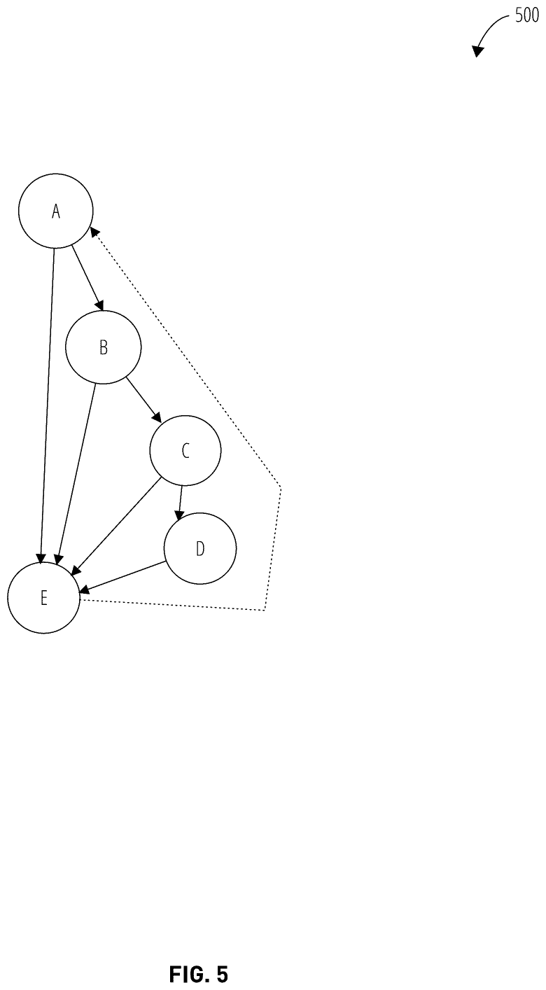

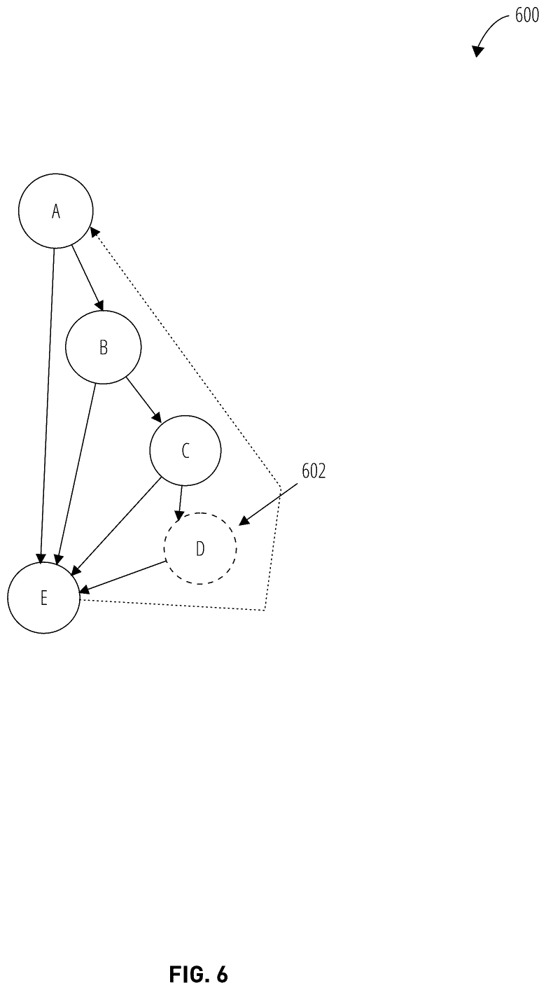

FIG. 3 illustrates a region of code 300 for a computer program written in the C++ computer language. FIG. 4 illustrates a flow diagram 400 corresponding to region of code 300. Control flow graph 500, found in FIG. 5, and control flow graph 600, found in FIG. 6, correspond to the data flow of FIG. 4 and the code of FIG. 3.

Referring back to FIG. 3, region of code 300 is a simple example of a potential overflow situation. The final access to ‘buff’ could potentially overflow as it can overrun beyond the 32 elements allocated for storage. Those of skill in the art will know that various types of unsafe function calls may result in a potential security flaw in the code that can be exploited by a malicious actor. For example, in C/C++, char* buff function on tainted data is an unsafe function call because it can allow a security condition called a buffer overflow to happen and damage the integrity of the computer program. The buffer overflow can, potentially, allow an attacker to inject harmful code into the computer program and/or divert its control flow (also known as Return-Oriented Programming (ROP)).

FIG. 5 illustrates a diagram of an example control flow graph for a region of source code having a potential software vulnerability. The region of source code illustrated corresponds to region of code 300, respectively, found in FIG. 3 and FIG. 4.

A control flow graph is associated with the code of a computer program. The control flow graph is constructed during compilation of the source code 108 Control flow graph 500 for the region of code 300 is populated with all potential control flow paths for the region of code 300. Referring to FIG. 5, each instruction of code is represented by a circle and the paths through the code shown by arrows. Thus, four possible paths through region of code 300 are shown by control flow graph 500.

FIG. 6 illustrates a diagram of the example control flow graph of FIG. 5 with the potential software vulnerability highlighted. Referring back to FIG. 1, control flow graph 500, an intermediate representation 110, is produced when source code 108 is compiled by compiler 104. For example, control flow graph 500 can be input into the ML model 118 of machine learning engine 112 in software vulnerability detection system 106. In the case that a control flow graph 500 is received, the ML model 118 can be a GNN that produces analysis on the control flow graph 500 and produces output of ML model 122 as shown in FIG. 6. FIG. 6 illustrates that ‘D’, e.g., the instruction “gets buff” in region of code 300, includes a potential software vulnerability 602. Region of code 300 can then be input into static analyzer 114 for localized static analysis 120 where analysis is performed to determine the local conditions needed to express the potential software vulnerability. For example, in the region of code 300, the static analysis can include trying to operate such that the overrun condition is always met, e.g., that 32+1 elements must get written.

FIG. 7 illustrates a schematic diagram illustrating components of a computing system. It should be understood that aspects of the system described herein are applicable to both mobile and traditional desktop computers, as well as server computers and other computer systems. Components of computing system 700 may represent a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen as some examples. Accordingly, more or fewer elements described with respect to computing system 700 may be incorporated to implement a particular computing system.

Referring to FIG. 7, a computing system 700 can include at least one processor 704 connected to components via a system bus 712, a memory 708, and a computing device 702. A processor 704 processes data according to instructions of the software vulnerability detection system 106 including machine learning engine 112 and static analyzer 114, and/or operating system 714. The instructions, e.g., method 200, may be loaded into the computing device 702 and run on or in association with the operating system 714. The computing system 700 can further include a user interface system 710, which may include input/output (I/O) devices and components that enable communication between a user and the computing system 700. Computing system 700 may also include a network interface unit 706 that allows the system to communicate with other computing devices, including server computing devices and other client devices, over a network.

In operation, the proposed method provides a software developer with the location of the software vulnerability as well as local conditions, such as inputs or system state, that make the software vulnerability exploitable. The region of code with the software vulnerability can then be further evaluated to see if the region of code with the potential software vulnerability, when the local conditions are met, is possible or probable to occur during normal execution of the code. Developers can use the information from the generated report and the further evaluation to judge how likely the software vulnerability is to be exploited in operation and modify the computer program accordingly.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for detecting software vulnerabilities, comprising:
receiving a computer program comprising regions of code, each region of code including at least one function;
pruning a search space of the received computer program by:
applying a high-level model recognizing potential software vulnerabilities to the computer program to determine a region of the code of the regions of code that includes a potential software vulnerability;
performing a localized static analysis on the region of the code that includes the potential software vulnerability to determine a local condition that causes the potential software vulnerability to be expressed in the computer program; and
generating a report comprising:
the region of the code that includes the potential software vulnerability, including a location of the region of the code within the computer program, and
the local condition that causes the potential software vulnerability to be expressed in the computer program.

2. The method of claim 1, further comprising determining that the potential software vulnerability with the local condition that causes the potential software vulnerability is reachable in the computer program when using applied stimuli of the computer program.

3. The method of claim 1, wherein performing the localized static analysis on the region of code that includes the potential software vulnerability includes:
locating a function boundary of a function of the computer program before the region of code that includes the potential software vulnerability, and
statically analyzing the computer program from the function boundary forward to the region of code to determine the local condition that causes the potential software vulnerability to be expressed in the computer program.

4. The method of claim 1, wherein performing the localized static analysis on the region of code that includes the potential software vulnerability includes:
locating a function boundary of a function of the computer program before the region of code that includes the potential software vulnerability;
statically analyzing the computer program backward from the region of the code to the function boundary to determine the local condition that causes the potential software vulnerability to be expressed in the computer program.

5. The method of claim 1, wherein the computer program is a source code.

6. The method of claim 5, wherein the high-level model is a deep learning model that utilizes a large language model (LLM).

7. The method of claim 1, wherein the computer program is an intermediate representation of source code.

8. The method of claim 7, wherein the high-level model is a deep learning model that utilizes a Graph Neural Network (GNN).

9. The method of claim 1, wherein the local condition is an input to the function included in the region of the code that includes the potential software vulnerability.

10. The method of claim 1, wherein the local condition is a system state of a processor that executes the computer program when the region of code that includes the potential software vulnerability is executed.

11. The method of claim 1, further comprising creating an exploitation of the potential software vulnerability utilizing the high-level model to determine the local conditions that cause the potential software vulnerability to be expressed in the computer program.

12. The method of claim 3, further comprising generating a set of conditions for the function at the function boundary utilizing the potential software vulnerability and the local condition that causes the potential software vulnerability to be expressed in the computer program to prevent the potential software vulnerability from being expressed in the computer program.

13. A non-transitory computer-readable storage medium, the computer-readable storage medium including instructions that when executed by a processing element perform a method, the method comprising:
receiving a computer program comprising regions of code, each region of code including at least one function;
pruning a search space of the received computer program by:
applying a high-level model recognizing potential software vulnerabilities to the computer program to determine a region of the code of the regions of code that includes a potential software vulnerability;
performing a localized static analysis on the region of the code that includes the potential software vulnerability to determine a local condition that causes the potential software vulnerability to be expressed in the computer program; and
generating a report comprising:
the region of the code that includes the potential software vulnerability, including a location of the region of the code within the computer program, and
the local condition that causes the potential software vulnerability to be expressed in the computer program.

14. The non-transitory computer-readable storage medium of claim 13, further comprising instructions that direct the processing element to:
determine that the potential software vulnerability with the local condition that causes the potential software vulnerability is reachable in the computer program when using applied stimuli of the computer program.

15. The non-transitory computer-readable storage medium of claim 13, wherein the instructions to perform the localized static analysis on the region of code that includes the potential software vulnerability direct the processing element to:
locate a function boundary of a function of the computer program before the region of code that includes the potential software vulnerability, and
statically analyze the computer program from the function boundary forward to the region of code to determine the local condition that causes the potential software vulnerability to be expressed in the computer program.

16. The non-transitory computer-readable storage medium of claim 13, wherein the instructions to perform the localized static analysis on the region of code that includes the potential software vulnerability direct the processing element to:
locate a function boundary of a function of the computer program before the region of code that includes the potential software vulnerability, and
statically analyze the computer program from the function boundary backward from the region of the code to the function boundary to determine the local condition that causes the potential software vulnerability to be expressed in the computer program.

17. The non-transitory computer-readable storage medium of claim 13, wherein the computer program is a source code.

18. The non-transitory computer-readable storage medium of claim 17, wherein the high-level model is a deep learning model that utilizes a large language model (LLM).

19. The non-transitory computer-readable storage medium of claim 17, wherein the computer program is an intermediate representation of source code.

20. The non-transitory computer-readable storage medium of claim 19, wherein the high-level model is a deep learning model that utilizes a Graph Neural Network (GNN).
